(19) United States
(12) Patent Application Publication
(10) Pub. No.: US 2014/0217208 A1
(43) Pub. Date: Aug. 7, 2014

(54) SYSTEM AND METHOD FOR DISPOSING OF CONFIDENTIAL INFORMATION

(71) Applicants: Costas Menico, Fort Lee, NJ (US); Daniel Meidan, Tenafly, NJ (US)

(72) Inventors: Costas Menico, Fort Lee, NJ (US); Daniel Meidan, Tenafly, NJ (US)

(21) Appl. No.: 13/758,241

(22) Filed: Feb. 4, 2013

(51) Int. Cl. B02C 23/36

(52) U.S. Cl. CPC B02C 23/36
USPC 241/21; 241/46.02

(57) ABSTRACT

Paper products having identity theft information such as personal/ confidential information thereon should be periodically destroyed. These sheets of paper are loaded into a mashing container being a flexible container that allows water to enter and exit but not the mashed paper. A sealable top should prevent the container from opening when it is being processed. The loaded mashing container is then placed into a conventional washing machine, one embodiment, and by means of the vanes of the agitator, the paper is mashed during a washing cycle. After this cycle, the washer is placed in the spin mode to remove as much water from the pulp as possible. The processed mashing container is removed and the top opened so that the pulp can be removed and placed in the garbage. Alternatively, the processed mashing container may itself be placed in the garbage.

### CROSS REFERENCES TO RELATED APPLICATIONS

This is the regular utility filing of provisional patent application 61/600,972, filed Feb. 20, 2012, titled “Paper Masher.”

### REFERENCE TO FEDERALLY SPONSORED RESEARCH OR DEVELOPMENT

NA

### REFERENCE TO JOINT RESEARCH AGREEMENTS

NA

### REFERENCE TO SEQUENCE LISTING

NA

### BACKGROUND OF THE INVENTION

1. Field of the Invention

The present invention relates generally to identity theft, and, particularly, relates to means for disposing of personal and confidential information, and, in greater particularly, relates to means for disposing of personal and confidential information contained upon hard products such as paper.

2. Description of the Prior Art

With the increased use of the Internet to purchase merchandise, the Internet has created one of the biggest opportunities for fraud and it is only going to get worse. In fact, ID fraud is one of the biggest new crimes. Shoppers in greater numbers are going online to purchase items by either credit card or debit card. Even though online statements provide complete information, many people still prefer to have a hard copy of purchases and transactions on their cards. Further personal information is also provided to the consumer for many different reasons in the mail. All of these hard paper documents create a strong possibility of identify theft if not properly disposed of.

With the proliferation of numerous paper documents having personal and confidential information thereon, consumers should dispose of these papers as soon as it is practical. Throwing these papers into the garbage is asking for trouble because many identify thieves routinely collect garbage looking for these important paper documents. To control this process, consumers have turned paper shedders. These shedders can be quite expensive and over time the cutters become dull. This leads to paper jams. Normally one can reverse the cutter heads to clear the jams, but this can be time consuming if one has to remove by hand pieces of paper stuck in the cutting blade area. The other question is whether in fact these shedders truly destroy the information so that identify thieves can not reassemble this information like a jigsaw puzzle. Another solution that is more available to home owners is incineration. You place all of the documents in a paper sack or metal container and set them afire. As they burn, you move the material around so that documents are completely burned. In places having restricted access like in foreign countries, the use of thermite bombs in a burn barrel quickly destroy paper and plastic types of documents due to the very high temperatures produced. The use of fire destruction is not normally available to apartment dwellers and most city dwellers. For the destruction of large amounts of paper products, mobile services can be employed that come to your place of business and destroy the materials there and this may be only cost effective for large amounts. See also U.S. Pat. Nos. 4,207,760; 4,371,067; 7,600,705; 7,695,524; 8,028,550; 8,127,576; and 8,347,437 for background. Any patents, patent applications or other documents noted herein or in the information disclosure statements are incorporated herein.

Accordingly, there is a need for a system and method for allowing disposal of papers containing personal and confidential information that is available to any person.

### SUMMARY OF THE INVENTION

The disposal of paper products having personal and confidential information thereon should be available to all consumers in order to protect against identity theft.

Paper products having personal and confidential information thereon should be periodically gathered by the consumer. These paper products should have plastic and metal objects removed preferably. These paper products, usually sheets of paper, are then loaded into a mashing container. In a first embodiment, the mashing container is a plastic or similar material container, usually a flexible bag with a sealable top, with a plurality of holes therein to allow water to enter and exit easily, but prevent paper pulp from coming out in significant quantities. The sealable top should prevent the container from opening when it is being processed. The loaded mashing container is then placed into a conventional washing machine either front or top loading. Depending on the size of the loaded mashing container, a water level is selected for small, medium or large loads. At this point, the water is allowed to enter into the drum to the appropriate level. After the water has entered, the washing cycle may be interrupted for a given period of time to allow the water and paper to fully interact. After this period of time, the wash cycle is selected for normal and the time is selected also. During the washing cycle, the agitator vanes repeatedly hit the loaded mashing container and break apart the paper to form a pulp-like mass. After this cycle, the washer is placed in the spin mode to remove as much water from the pulp as possible. The processed mashing container is removed and the top opened so that the pulp can be removed and placed in the garbage. Alternatively, the processed mashing container may itself be placed in the garbage thus requiring the purchase of additional containers.

In another embodiment, the mashing container may be formed of a material less flexible so providing a container having a removable top cover. Since the agitator vanes will not directly impinge on the paper from the outside as in the flexible bag, solid objectives like plastic cubes can be loaded also into the mashing container to turn the paper into a pulp.

In another embodiment, where the destruction of confidential information on paper products is almost a daily occurrence, a dedicated mashing machine would be available. In a further embodiment of this version of the present invention, the paper may be loaded directly into the mashing drum. The amount of paper so loaded would be weighted for example to insure a proper load so that when the paper is fully mashed, the resulting pulp and water combination could be flushed down a drain for this machine.

In a still further embodiment, a spin cycle would remove substantially all water leaving just the pulp. An inner container having the pulp therein could be removed and the pulp dumped therefrom; otherwise a scoop would be required to remove the pulp mass.

An objective of the present invention is to provide a system and process for the destruction of personal and confidential information on paper products.

It is another objective of the present invention to provide a system and process for the destruction of personal and confidential information by use of water.

It is a further objective of the present invention to provide a system and process for the destruction of personal and confidential information that can be used by the consumer either in a home or an apartment.

It is still a further objective of the present invention to provide a system and process for the destruction of personal and confidential information on paper products that turns the paper into a mash-like mass by the use of a washing machine-device.

It is yet a further objective of the present invention to provide a system and process for the destruction of personal and confidential information that is easily, and quickly carried out by the consumer.

It is yet a further objective of the present invention to provide a system and process for the destruction of confidential information on a larger scale using a dedicated mashing machine.

These and other objectives, features, and advantages of the present invention will become more readily apparent from the attached drawings and the detailed description of the preferred embodiments, which follow.

### BRIEF DESCRIPTION OF THE DRAWINGS

FIG. 1 is a block flow diagram of the present invention;

FIG. 2 illustrates one embodiment of a mashing container being a flexible water permeable bag;

FIG. 3 illustrates the process of the present invention using a conventional type of washing machine to mash the paper inside of the mashing container; and

FIG. 4 illustrates a mashing container for use in a top loading washing machine

Like reference numerals refer to like parts throughout the several views of the drawings.

### DETAILED DESCRIPTION OF THE PREFERRED EMBODIMENTS

Identity theft is fast becoming one of the most frequently seen crimes on the Internet. Many people are relying more and more on the Internet for purchases and thus creating numerous virtual documents. This information must be protected from unauthorized access, but hard copies of many documents such as bank statements, purchase receipts, etc., having personal and confidential information thereon are still created and retained by the consumer as backup. These paper products should be periodically gathered by the consumer for destruction.

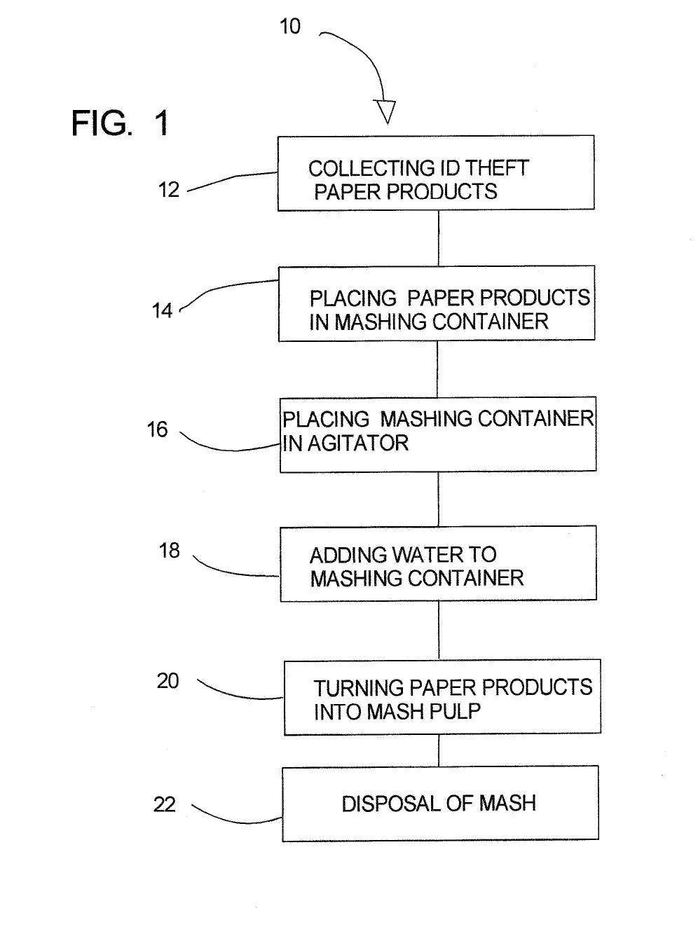

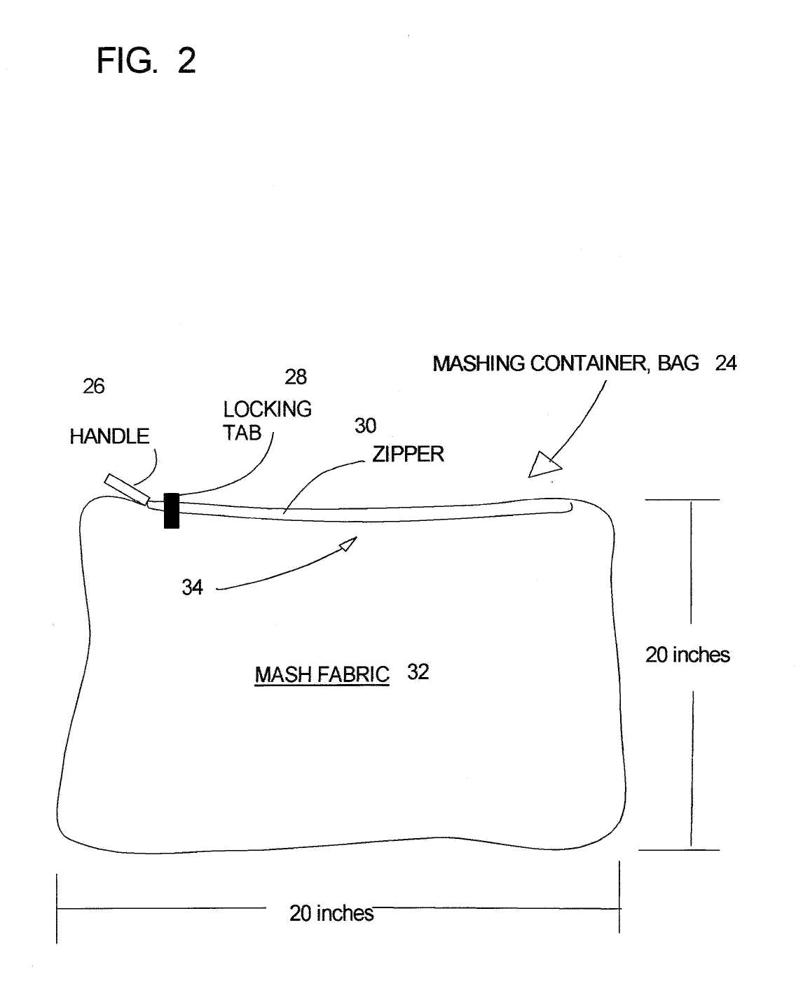

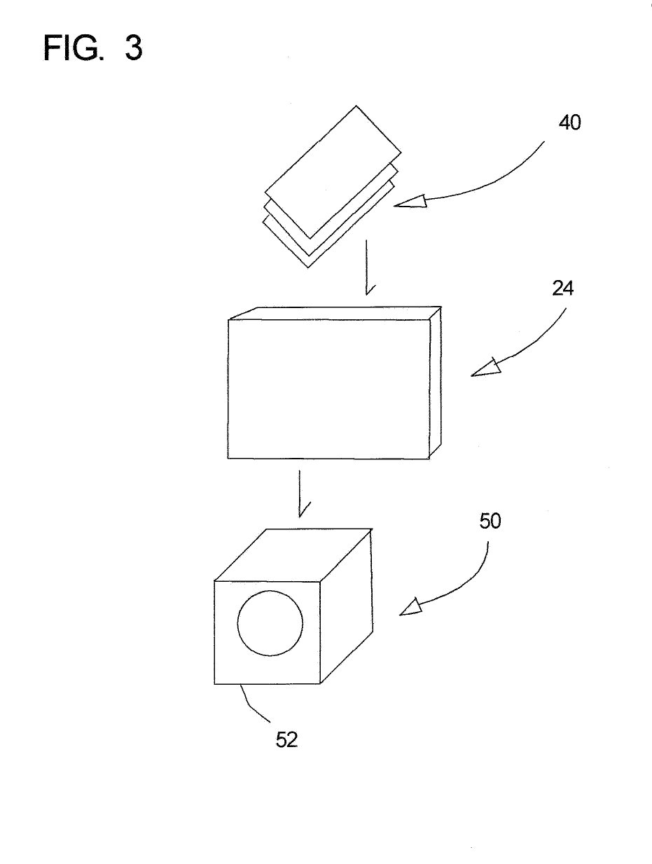

Referring to FIG. 1, a system and method 10 for the destruction of identity theft information is shown. These ID theft personal and confidential paper products, usually sheets of paper, are collected 12 are then loaded into a mashing container 14. In a first embodiment, the mashing container 24, as shown in FIG. 2, is a plastic or similar material such as organza fabric bag 24 having a plurality of holes therein to allow water to enter and exit easily, but also preventing the paper pulp from coming out in any significant quantities. A sealable top 34 should prevent the bag 24 from opening when it is being processed. As seen therein, the sealable top 34 is a zipper 30 having a handle 26. A hook and loop device or a locking tab 28 is placed over the zipper 30 when it is closed to prevent the zipper 30 from becoming undone when in an agitator. The sheets of paper 40, FIG. 3, are then loaded into mashing container 24 which is then placed into a conventional washing machine 50 either front loading washing machine 52 or top loading or similar device that provides water input and removal and agitation to the sheets of papers 40 to turn them into a mash or pulp product that is then disposed of. Depending on the size of the loaded mashing container 24, a water level is selected for small, medium or large loads. At this point, the water is allowed to enter into the drum to the appropriate level. After the water has entered and remained there for a given period to soak the paper, the washing cycle is selected for an appropriate mode such as normal and the time is selected also. During the washing cycle, the agitator vanes, not shown, repeatedly hit the loaded mashing container 24 and break apart the paper to form a pulp-like mass. After this cycle, the washing machine is placed in the spin mode to remove as much water from the pulp as possible. The processed mashing container 24 is then removed and the top opened so that the pulp can be removed and placed in the garbage. Alternatively, the processed mashing container 24 may itself be placed in the garbage thus requiring the purchase of additional containers.

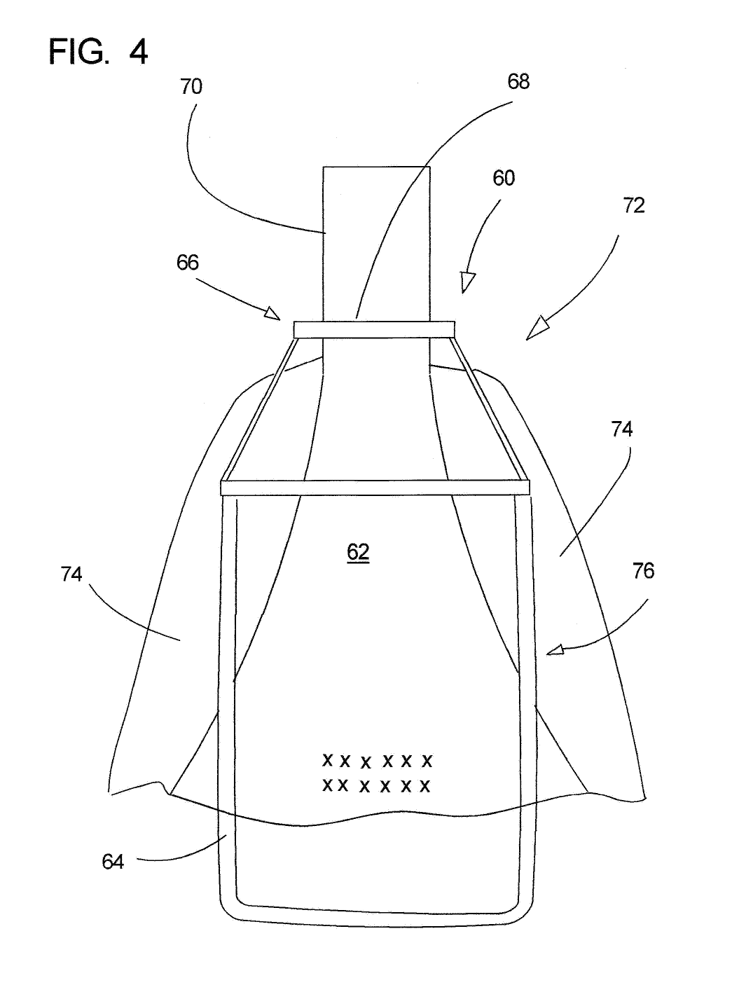

In another embodiment, FIG. 4, the mashing container 60 may be formed of a material less flexible, such as a screen 62, being plastic or metal, and/or a frame of rods 64, plastic or metal, so providing a container 60 having a removable top cover, as needed, and a fixed shape. The mashing container 60 may have a top 66 with a circular attachment means 68 that fits over a top section 70 of an impeller 72 with a plurality of vanes 74. Objects may be added into the screened container section 76 to assist in mashing paper placed in the section 76 since the mashing container 72 will be held within a section of the impeller 72 not having vanes 74. Since the agitator vanes 74 will not directly impinge on the paper from the outside as in the flexible bag embodiment shown above, solid objects like plastic cubes can be loaded also into the mashing container 72 to turn the paper into a pulp.

In yet a further embodiment, the loaded mashing container can just be placed into a sink of water and allowed to soak. After which the loaded mashing container is vigorously shook until the paper is turned into a mash. These embodiments can be carried out by the consumer in a typical house/apartment.

In another embodiment, where the destruction of confidential information on paper products is almost a daily occurrence, a dedicated mashing machine would be available such as a commercial washing machine or the like. In a further embodiment of this version of the present invention, the paper may be loaded directly into the mashing drum and thus it becomes the mashing container. The amount of paper so loaded would be weighted for example to insure a proper load so that when the paper is fully mashed, the resulting pulp and water combination could be flushed down a drain for this machine without a problem of clogging the drain. This type of machine would have fewer controls such as a timer, load size, on/off, etc.

As described above, a system 10 for the destruction of identity theft information being contained on paper products is described: the paper products such as a plurality of sheets of paper is collected for disposal where the disposal renders any information on the paper products beyond recognition or reconstruction for such. The system 10 uses a container for holding one or more paper products where the container is water permeable to fully wet, quickly and easily, the paper products placed therein. Although water is used for wetting the paper products other fluids are clearly possible as shown and described in one or more patents noted above. The container has a means for removably covering an opening in the container to prevent the paper products from exiting unintentionally. Also a mashing machine such as a conventional washing machine is used to input and remove water from the mashing container. While in the mashing machine, the container is agitated with water therein to turn the paper products into a mash of pulp. The excess water in the mashing container is removed and then the mash or pulp is removed from the container and thrown away. The mashing container may also be thrown away directly but additional containers would be required.

The method in general for implementing this invention requires the collecting of one or more paper products for disposal, typically being sheets of papers, the disposal rendering any information on the paper products beyond recognition or reconstruction for such; providing a container for holding one or more paper products, said container being water permeable to fully wet said one or more paper products placed therein; providing a means for removably covering an opening in said container to prevent said one or more paper products from exiting unintentionally; providing a means for inputting and removing water from said container; providing a means for agitating said container with one or more paper products mixed with water therein, said means for agitating turning said one or more paper products into a mash or pulp; and disposing of the mash or pulp.

Since many modifications, variations, and changes in detail can be made to the described embodiments of the invention, it is intended that all matters in the foregoing description and shown in the accompanying drawings be interpreted as illustrative and not in a limiting sense. Thus, the scope of the invention should be determined by the appended claims and their legal equivalents.

What is claimed is:

1. A method for the destruction of identity theft information, the information being contained on paper products, said method comprising the steps of:
collecting one or more paper products for disposal, the disposal rendering any information on the paper products beyond recognition or reconstruction for such;
providing a container for holding one or more paper products, said container being water permeable to fully wet said one or more paper products placed therein;
providing a means for removably covering an opening in said container to prevent said one or more paper products from exiting unintentionally;
providing a means for inputting and removing water from said container;
providing a means for agitating said container with one or more paper products mixed with water therein, said means for agitating turning said one or more paper products into a mash of pulp; and
disposing of said mash of pulp.

2. The method as defined in claim 1, wherein said one or more paper products are sheets of paper.

3. The method as defined in claim 1, further providing said container to have flexible walls through which water is easily and quickly input and removed from said container as desired.

4. The method as defined in claim 3, further providing flexible walls to said container, the flexible walls comprising one or more materials such as organza fabric.

5. The method as defined in claim 1, further providing said container with a zipper-like device for closing said opening.

6. The method as defined in claim 5, further providing a means for preventing said zipper-like device from opening during agitation.

7. The method as defined in claim 1, wherein said means for inputting and removing water from said container is selected from the group comprising top loading washing machines and front loading washing machines.

8. The method as defined in claim 1, further said means for agitating said container with one or more paper products mixed with water therein is selected from the group comprising top loading washing machines, front loading washing machines, or similar machines, said machines having means to control a water input, control a length of agitation, and a removal of water therefrom, said means for agitating turning said one or more paper products into a mash of pulp.

9. A system for the destruction of identity theft information, the information being contained on paper products, said system comprising:
one or more paper products being collected for disposal, the disposal rendering any information on the paper products beyond recognition or reconstruction for such;
a container for holding one or more paper products, said container being water permeable to fully wet said one or more paper products placed therein, said container holding said paper products during agitation;
a means for removably covering an opening in said container to prevent said one or more paper products from exiting unintentionally;
a means for inputting and removing water from said container;
a means for agitating said container with one or more paper products mixed with water therein, said means for agitating turning said one or more paper products into a mash of pulp; and
a means for disposing of said mash of pulp.

10. The system as defined in claim 9, wherein said one or more paper products are one or more sheets of paper.

11. The system as defined in claim 9, further comprising said container having screen-like walls and a frame for holding said screen-like walls in a predetermined shape.

12. The system as defined in claim 9, further comprising said container having flexible walls through which water is easily and quickly input and removed from said container as desired, and said flexible walls being able to withstand agitation sufficiently to allow the paper products to be turned in a mash therein.

13. The system as defined in claim 12, wherein said flexible walls comprise one or more flexible materials such as organza fabric or similar plastic materials.

14. The system as defined in claim 9, wherein said container has a zipper-like device for closing said opening.

15. The system as defined in claim 14, further including a means for preventing said zipper-like device from opening during agitation.

16. The system as defined in claims 15, wherein said container comprises two rectangular panels of flexible material and having four edges on the panels, said panels being permanently joined at three of the four edges and along the fourth edge having said zipper-like device thereon to form a bag like structure for holding paper products.

17. The system as defined in claim 16, wherein said container is approximately 20 inches by 20 inches.

18. The system as defined in claim 1, wherein said means for inputting and removing water from said container is selected from the group comprising top loading washing machines and front loading washing machines.

19. The system as defined in claim 1, wherein said means for agitating said container with one or more paper products mixed with water therein is selected from the group comprising top loading washing machines, front loading washing machines, or similar machines, said machines comprising means to control a water input, control a length of agitation, and a control for removal of water therefrom, said means for agitating turning said one or more paper products into a mash of pulp.
